(19) United States
(12) Patent Application Publication
(10) Pub. No.: US 2006/0142446 A1
(43) Pub. Date: Jun. 29, 2006

(54) Process for stabilization of polymer compositions

(76) Inventors: Hayder Zahalka, Morgantown, WV (US); Marshall D. Moore, Morgantown, WV (US)

Correspondence Address: Mr. Dan Reitenbach;CHEMTURA CORPORATION - IP Legal, Benson Road, Middlebury, CT, 06749, US

(21) Appl. No.: 11/359,900

(22) Filed: Feb. 21, 2006

Related U.S. Application Data
(63) Continuation of application No. 10/621,751, filed on Jul. 17, 2003.
(60) Provisional application No. 60/442,501, filed on Jan. 24, 2003.

(51) Int. Cl. C08K 5/32

(52) U.S. Cl. 524/236; 524/430; 524/436; 524/437; 524/217; 524/130; 524/132; 524/425

(57) ABSTRACT

Stabilized flame retardant polymer compositions containing a hydrated metal compound, e.g., a metal hydroxide, as a flame retardant, when added an effective stabilizing amount of an amine oxide, a hydroxyl amine or mixtures thereof, exhibit desirable physical characteristics of pure polymers due to the stabilizer additives, including excellent color stability, while attaining desirable fire-retardance standards.

### CROSS-REFERENCE TO RELATED APPLICATIONS

This patent application claims priority date of U.S. Provisional Patent Application No. 60/442,501, filed Jan. 24, 2003.

### FIELD OF THE INVENTION

The invention relates generally to an improved stabilized flame-retardant thermoplastics and thermosetting compositions and an improved process to stabilize polymer compositions.

### BACKGROUND

Stabilization is defined as protection of deterioration of the polymer compositions during processing at high temperatures. This is needed in a number of applications to enhance resistance to thermal and light degradation and withstand more rigorous conditions. Stabilization in polymer compositions is typically achieved by incorporation of certain additive compounds. Broadly, these additives could be classified as phenolics (for example hindered phenolics) and non-phenolics (for example hydroxyl amines, amine oxides, lactones, thioesters and phosphites).

With respect to polymer resins in the form of polyolefins, polyolefin resins are easily combustible themselves. It is therefore necessary to impart flame retardancy to polyolefin resins for use in a number of applications. It is known in the art to add to polyolefin compositions a halogen-free safe flame-retardant such as a metal hydrates or metal oxides, e.g., alumina trihydrate and magnesium hydroxide or oxide. However, a large amount of such flame-retardant must be added to a flame resistant composition to ensure adequately high flame resistance.

U.S. Pat. No. 6,162,851 discloses the incorporation of certain additives to flame retardant polymers such as polyolefins for molding applications, specifically a primary antioxidant during melt compounding such as hindered phenols and secondary aryl amines, to protect the polyolefin from thermal oxidative degradation which is initiated via free radical formation, i.e., loss of physical properties, changes in molecular weight, molecular weight distribution, and the like. The reference further discloses the incorporation of secondary antioxidants, e.g., phosphites and thioesters, into the flame retardant composition during melt compounding to help prevent the chain-branching resulting from the decomposition of hydroperoxides into free radicals.

It has been discovered that stabilizer additive, e.g., an amine oxide, nitrone, nitroxyl, and a hydroxyl amine stabilizer, which if incorporated into flame retardant thermoplastics and thermosetting resins containing a metal hydrates or metal oxides as a flame retardant agent, provide better protection against polymer degradation as evidenced by changes in melt flow and provide better resistance to discoloration (yellowing) compared to those polymer compositions stabilized with the conventional stabilizers additives which includes hindered phenolic and phosphites.

### SUMMARY OF THE INVENTION

The invention relates to a flame-retardant polymer composition comprising: a) 100 weight parts of a polymer resin; b) at least about 5 weight parts of a hydrated metal compound; and c) an effective stabilizing amount of an amine oxide or a hydroxyl amine in conjunction with an organophosphorus compound.

The invention further relates to a method for stabilizing flame-retardant polymer compositions comprising mixing into such polymer compositions up to 60 parts of a hydrated metal compound per 100 parts of polymer resin and an effective stabilizing amount of an amine oxide, hydroxyl amine, nitrone, nitroxyl stabilizer, and an organophosphorus compound.

Lastly, the invention relates to a method for stabilizing flame-retardant thermoplastics and thermosetting resins comprising mixing into such polymer compositions up to 60 parts of a hydrated metal compound per 100 parts of polymer and an effective stabilizing amount of an amine oxide, hydroxyl amine, nitrone, nitroxyl stabilizer, and an organophosphorus compound, wherein said polymer is thermoplastics and thermosetting resins, such as polypropylene, polyethylene, EVA, polypropylene blends, ABS, ABS alloys and blends, PPO, PPO alloys and blends, thermoplastic elastomers (TPE), thermoplastic olefin (TPO), etc.

### DESCRIPTION OF THE INVENTION

The present invention relates to stabilized flame retardant polyolefin compositions containing a hydrated metal compound, e.g., a metal hydroxide, as a flame retardant, and an effective stabilizing amount of a synergistic stabilizer, e.g., an amine oxide, a hydroxyl amine, nitrone, nitroxyl stabilizer, and an organophosphorus compound or mixtures thereof. In one embodiment, the polymer compositions exhibit desirable process stabilization and better color than those observed with the conventional stabilizers additives which includes hindered phenolic and phosphates, during extrusion, polymer processing, polymer exposure to weathering, heat, and light.

POLYMER RESIN COMPONENT: The polymer resin component may be any thermoplastic polymer resin or thermoset polymer resin known in the art. Non-limiting examples of thermoplastic polymers include polyolefin homopolymers and copolymers, polyurethanes, polyalkylene terephthalates, polysulfones, polyimides, polyphenylene ethers, styrenic polymers and copolymers, polycarbonates, acrylic polymers, polyamides, polyacetals, and halide containing polymers, and blends thereof. Mixtures of different polymers, such as polyphenylene ether-styrenic resin blends, polyvinyl chloride-Acrylonitrile-butadiene-styrene (also sometimes hereinafter called “ABS”) or other impact modified polymers, such as methacrylonitrile and alpha-methylstyrene containing ABS, and polyester-ABS or polycarbonate-ABS and polyester plus some other impact modifier may also be used. Such polymers are available commercially or may be made by means well known in the art.

In one embodiment, the stabilized polymer resins are thermoset resin compositions, such as polyurethanes, epoxides, melamine, and phenolics; and may be useful in thermoset plastic blends.

Polymer resins of monoolefins and diolefins include, for example polypropylene, polyisobutylene, polybutene-1, polymethylpentene-1, polyisoprene, or polybutadiene, as well as polymers of cycloolefins, for instance of cyclopentene or norbornene, polyethylene (which optionally can be crosslinked), for example high density polyethylene (HDPE), low density polyethylene (LDPE), very low density polyethylene (VLDPE) and linear low density polyethylene (LLDPE) may be used. Mixtures of these polymers, for example, mixtures of polypropylene with polyisobutylene, polypropylene with polyethylene (for example PP-HDPE, PP-LDPE) and mixtures of different types of polyethylene (for example LDPE-HDPE), may also be used. Also useful are copolymers of monoolefins and diolefins with each other or with other vinyl monomers, such as, for example, ethylene-propylene, LLDPE and its mixtures with LDPE, propylene-butene-1, ethylene-hexene, ethylene-ethylpentene, ethylene-heptene, ethylene-octene, propylene-isobutylene, ethylene-butene-1, propylene-butadiene, isobutylene, isoprene, ethylene-alkyl acrylates, ethylene-alkyl methacrylates, ethylene-vinyl acetate (EVA) or ethylene-acrylic acid copolymers (EAA) and their salts (ionomers) and terpolymers of ethylene with propylene and a diene, such as hexadiene, dicyclopentadiene or ethylidene-norbornene; as well as mixtures of such copolymers and their mixtures with polymers resins mentioned above, for example polypropylene-ethylene propylene-copolymers, LDPE-EVA, LDPE-EAA, LLDPE-EVA, and LLDPE-EAA.

The polymers resins of the present invention may also include styrenic polymers, such as polystyrene, poly-(p-methylstyrene), poly-(α-methylstyrene), copolymers of styrene or α-methylstyrene with dienes or acrylic derivatives, such as, for example, styrene/butadiene, styrene/acrylonitrile, styrene/alkyl methacrylate, styrene/maleic anhydride, styrene/maleimide, styrene/butadiene/ethyl acrylate, styrene/acrylonitrile/methyl acrylate, mixtures of high impact strength from styrene copolymers and another polymer, such as, for example, from a polyacrylate, a diene polymer or an ethylene/propylene/diene terpolymer; and block copolymers of styrene, such as, for example, styrene/butadiene/styrene, styrene/isoprene/styrene, styrene/ethylene/butylene/styrene or styrene/ethylene/propylene styrene. Styrenic polymers may additionally or alternatively include graft copolymers of styrene or alpha.-methylstyrene, such as for example, styrene on polybutadiene, styrene on polybutadiene-styrene or polybutadiene-acrylonitrile; styrene and acrylonitrile (or methacrylonitrile) on polybutadiene and copolymers thereof; styrene and maleic anhydride or maleimide on polybutadiene; styrene, acrylonitrile and maleic anhydride or maleimide on polybutadiene; styrene, acrylonitrile and methyl methacrylate on polybutadiene, styrene and alkyl acrylates or methacrylates on polybutadiene, styrene and acrylonitrile on ethylene-propylene-diene terpolymers, styrene and acrylonitrile on polyacrylates or polymethacrylates, styrene and acrylonitrile on acrylate/butadiene copolymers, as well as mixtures thereof with the styrenic copolymers indicated above.

Nitrile polymers are also useful in the polymer composition of the invention. These include homopolymers and copolymers of acrylonitrile and its analogs, such as polymethacrylonitrile, polyacrylonitrile, acrylonitrile/butadiene polymers, acrylonitrile/alkyl acrylate polymers, acrylonitrile/alkyl methacrylate/butadiene polymers, and various ABS compositions as referred to above in regard to styrenics.

Polymer resins based on acrylic acids, such as acrylic acid, methacrylic acid, methyl methacrylic acid and ethacrylic acid and esters thereof may also be used. Such polymers include polymethylmethacrylate, and ABS-type graft copolymers wherein all or part of the acrylonitrile-type monomer has been replaced by an acrylic acid ester or an acrylic acid amide. Polymers including other acrylic-type monomers, such as acrolein, methacrolein, acrylamide, and methacrylamide may also be used.

Halogen-containing polymers that may be used include resins, such as polychloroprene, epichlorohydrin homopolymers- and copolymers, polyvinyl chloride, polyvinyl bromide, polyvinyl fluoride, polyvinylidene chloride, chlorinated polyethylene, chlorinated polypropylene, fluorinated polyvinylidene, brominated polyethylene, chlorinated rubber, viny901 chloride-vinyl acetate copolymers, vinyl chloride-ethylene copolymer, vinyl chloride-propylene copolymer, vinyl chloride-styrene copolymer, vinyl chloride-isobutylene copolymer, vinyl chloride-vinylidene chloride copolymer, vinyl chloride-styrene-maleic anhydride terpolymer, vinyl chloride-styrene-acrylonitrile copolymer, vinyl chloride-butadiene copolymer, vinyl chloride-isoprene copolymer, vinyl chloride-chlorinated propylene copolymer, vinyl chloride-vinylidene chloride-vinyl acetate terpolymer, vinyl chloride-acrylic acid ester copolymers, vinyl chloride-maleic acid ester copolymers, vinyl chloride-methacrylic acid ester copolymers, vinyl chloride-acrylonitrile copolymer and internally plasticized polyvinyl chloride.

Other useful polymer resins include homopolymers and copolymers of cyclic ethers, such as polyalkylene glycols, polyethylene oxide, polypropylene oxide or copolymers thereof with bis-glycidyl ethers; polyacetals, such as polyoxymethylene and those polyoxymethylenes which contain ethylene oxide as a comonomer; polyacetals modified with thermoplastic polyurethanes, acrylates or methacrylonitrile containing ABS; polyphenylene oxides and sulfides, and mixtures of polyphenylene oxides with polystyrene or polyamides; polycarbonates and polyester-carbonates; polysulfones, polyethersulfones and polyetherketones; and polyesters which are derived from dicarboxylic acids and diols and/or from hydroxycarboxylic acids or the corresponding lactones, such as polyethylene terephthalate, polybutylene terephthalate, poly-1, 4dimethylol-cyclohexane terephthalate, poly-2(2,2,4(4-hydroxyphenyl)-propane) terephthalate, and polyhydroxybenzoates; as well as block copolyetheresters derived from polyethers having hydroxyl end groups.

Suitable polymer resins also include polyamides and copolyamides derived from bisamines and dicarboxylic acids and/or from aminocarboxylic acids or the corresponding lactams, such as polyamide 4, polyamide 6, polyamide 6/6, 6/10, 6/9, 6/12 and 4/6, polyamide 11, polyamide 12, aromatic polyamides obtained by condensation of m-xylene bisamine and adipic acid; polyamides prepared from hexamethylene bisamine and isophthalic and/or/terephthalic acid and optionally an elastomer as modifier, for example poly-2,4,4 trimethylhexamethylene terephthalamide or poly-m-phenylene isophthalamide. In other embodiments, copolymers of the aforementioned polyamides with polyolefins, olefin copolymers, ionomers, or chemically bonded or grafted elastomers; or with polyethers, such as for instance, with polyethylene glycol, polypropylene glycol or polytetramethylene glycols and polyamides or copolyamides modified with ethylene propylene diene monomer (EPDM) or ABS may be used.

In one embodiment, the thermoplastic polymer is one of polyolefins, polycarbonates, polyphenylene ethers and styrenic polymers, or a mixture thereof. In another embodiment, the polymer is one of polyethylene, polypropylene, polyethylene terephthalate, polyphenylene ether homopolymers and copolymers, polystyrene, high impact polystyrene, polycarbonates and ABS-type graft copolymers and mixtures thereof.

In yet another embodiment, the polymer resins are propylene resins comprising solely of one or more propylene homopolymers, one or more propylene copolymers, and blends of one or more of each of propylene homopolymers and copolymers. In one embodiment, the polypropylene comprises at least 70 weight percent propylene monomer derived units. In a second embodiment, at least 90. In a third embodiment, 100 wt. % propylene monomer derived units.

The polymer resin is in a range between about 25 and about 95 percent by weight based on the total weight of the composition. In a second embodiment, the resin is in a range between about 50 and about 90 percent by weight based on the total weight of the composition. In a third embodiment, the resin is in a range between about 65 and about 80 percent by weight based on the total weight of the composition.

Hydrated Metal Compound as Flame Retardants. The flame retardant for use in the polymer compositions of the present invention is a hydrated metal compound selected from dihydric or trihydric metal hydroxides such as aluminum hydroxide, magnesium hydroxide, zirconium hydroxide, calcium hydroxide, barium hydroxide, calcium aluminate hydrate and the like. Furthermore, the dihydric or trihydric metal hydroxide may be a composite metal hydroxide which is a solid solution in which at least one of nickel, cobalt, manganese, iron, copper and zinc is dissolved in any one of the above metal hydroxides. The dihydric or trihydric metal hydroxide may be any one of natural and synthetic products. In one embodiment, the hydrated metal compound is a magnesium hydroxide. In a second embodiment, the flame retardant is an aluminum hydroxide.

In one embodiment, the metal hydroxide has a particle diameter of about 0.1 to 10 μm. In a second embodiment, the metal hydroxide has a particle size of about 0.3 to 6 μm.

In one embodiment of the invention, the metal hydroxide used is surface-treated prior to being incorporated into the polymer composition. The surface treatment is done via a saturated fatty acid having 10 to 30 carbon atoms or an alkali metal salt thereof. The saturated fatty acid includes stearic acid, behenic acid, capric acid, undecanoic acid, lauric acid, myristic acid, arachic acid, lignoceric acid, cerotic acid, montanic acid and melissic acid. The unsaturated fatty acid includes oleic acid, erucic acid, obtusilic acid, caproleic acid, undecylenic acid, linderic acid, tsuzuic acid, physeteric acid, myristoleic acid, palmitoleic acid, petroselinic acid, elaidic acid, cis-II-octadecenoic acid, vaccenic acid, gadoleic acid, cis-II-eicosenoic acid, cetoleic acid, brassidic acid, selacholeic acid, ximenic acid, lumequeic acid, linoleic acid and linolenic acid. The alkali metal includes lithium, potassium and sodium. This surface treatment of the metal hydroxide enhances the compatibility between the metal hydroxide and the polymer resin composition, improves the processability of the resin composition, inhibits the surface whitening phenomenon and improves the low-temperature resistance. The surface-treated metal hydroxide shows excellent compatibility with polymer resins such as polyolefins, and thus can be easily dispersed in the resin.

The amount of metal hydroxide flame retardant used in the composition of the present invention is about 5-300 parts by weight or more, per 100 parts by weight of the polymer resin component. In one embodiment, the amount used is about 10 to 200 parts by weight of metal hydroxide flame retardant per 100 parts by weight of the polymer resin. In a third embodiment, the amount is at least 5 parts by weight of metal hydroxide flame retardant per 100 parts by weight of the polymer resin component. In a fourth embodiment, the amount is at least 10 parts by weight of metal hydroxide per 100 parts by weight of the polymer resin component.

Synergistic Stabilizer Components. Applicants have found that the addition of certain stabilizer additives protects the flame-retardant polymer resin composition from thermal oxidative degradation and furthermore, surprisingly provides superior color stabilizing effect. Examples of synergistic stabilizers include amine oxides, hydroxyl amines, nitrone, nitroxyl stabilizer, benzofuranone stabilizer, quinone methide stabilizer, monoacrylate esters of 2,2′-alkylidenebisphenol stabilizer, in combination with at least an organophosphite, a phosphonite, or mixtures thereof added in a stabilizing amount, or an amount sufficient or useful to protect against discoloration and degradation caused by high temperatures as expected in normal polymer processing conditions, or upon light and weathering exposure.

Generally, the “stabilizing amount” or “effective stabilizing amount” of stabilizers needed in the flame retardant thermoplastic composition of this invention will depend upon several factors, including, but not limited to, the particular metal hydroxide flame retardant compound employed, the particular polymer resin to be stabilized, the severity of processing, heat, light and weathering to which the resin will be subjected and the degree of stabilization desired. Thus, the amount of the stabilizer component used may vary widely, it being required only that a sufficient or effective amount of the stabilizer is added to improve the color stability of the flame retardant composition of the present invention as compared to a polymer composition without the stabilizers of the present invention, and that the metal hydroxide flame retardant is present in an amount which will synergize such stabilization.

While this stabilizing amount can vary as indicated above, in one embodiment, the amount can be as little as 100 ppm of the stabilizer component with the polymer resin component. In another embodiment, this amount is in the range of about 500-1000 ppm. Amounts greater than this range can be employed, although at some point the increase in stabilization of the polymer resin is not commensurate with the additional amount of stabilizer employed. While there is no critical upper limit to the amount of stabilizer composition which may be employed, amounts in excess of about 2 wt. % do not give an increase in effectiveness which will justify the use of these higher amounts of stabilizer.

First Stabilizer Additive: In one embodiment of the invention, the first stabilizer additive is an amine oxide. Amine oxide stabilizers are generally made by the oxidation of the corresponding amine with hydrogen peroxide, and synthesis of the amine oxide for use as the additive of the present invention is known in the art, see U.S. Pat. Nos. 5,866,718, 5,955,633, and references quoted therein. See also U.S. Pat. Nos. 5,081,300, 5,162,408, 5,844,029, 5,880,191 and 5,922,794, the relevant parts of each incorporated herein by reference.

In another embodiment, the amine oxide additive is a tertiary amine oxide of the general formula (I) 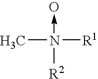
wherein R¹ and R² are each independently a C₈₋₃₀ alkyl moiety. In another embodiment, the R¹ and R² of formula (I) are each independently a C₁₆₋₁₈ alkyl moiety; and wherein the amine oxide picks up less than about 10% by weight water when stored at 23° C. and 80% relative humidity, and is a solid at 23° C. In yet another embodiment, the R¹ and R² are each independently a C₁₀ alkyl moiety; and wherein the amine oxide has a 10% weight loss rating of at least about 120° C., when measured at a heating rate of 20° C./minute. In yet another embodiment, the R¹ and R² are each independently a C₁₆₋₁₈ alkyl moiety; and wherein the amine oxide has a 10% weight loss rating of at least about 145° C., when measured at a heating rate of 20° C./minute.

The amine oxide stabilizers for use in the compositions of the present invention may also includes poly(amine oxides). By poly(amine oxides) is meant tertiary amine oxides containing at least two tertiary amine oxides per molecule. Illustrative poly(amine oxides), also called “poly(tertiary amine oxides)”, include the tertiary amine oxide analogues of aliphatic and alicyclic diamines such as, for example, 1,4-diaminobutane; 1,6-diaminohexane; 1,10-diaminodecane; and 1,4diaminocyclohexane, and aromatic based diamines such as, for example, diamino anthraquinones and diaminoanisoles.

Also included in the present invention are tertiary amine oxides derived from oligomers and polymers of the aforementioned diamines. Hindered amines are known in the art and the amine oxide of the present invention may be attached to the hindered amine in any manner and structural position of the hindered amine. Also included are amine oxides containing more than one hindered amine and more than one saturated amine oxide per molecule. The hindered amine may be attached to a poly(tertiary amine oxide) or attached to a polymer substrate.

In one embodiment, the first stabilizer additive is a nitrone, as for example, N-benzyl-alpha-phenyl nitrone, N-ethyl-alpha-methyl nitrone, N-octyl-alpha-heptyl nitrone, N-lauryl-alpha-undecyl nitrone, N-tetradecyl-alpha-tridecyl nitrone, N-hexadecyl-alpha-pentadecyl nitrone, N-octadecyl-alpha-heptadecylnitrone, N-hexadecyl-alpha-heptadecyl nitrone, N-octadecyl-.alpha-pentadecyl nitrone, N-heptadecyl-alpha-heptadecyl nitrone, N-octadecyl-alpha-hexadecyl nitrone, and nitrone derived from N,N-dialkylhydroxylamines derived from hydrogenated tallow amines.

In one embodiment, the first stabilizer additive is a hydroxylamine, as for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine, N,N-di-tert-butylhydroxylamine, N-cyclohexylhydroxylamine, N-cyclododecylhydroxylamine, N,N-dicyclohexylhydroxylamine, N,N-dibenzylhydroxylamine, N,N-didecylhydroxylamine, N,N-di(coco alkyl)hydroxylamine, N,N-di(C₂₀-C₂₂ alkyl) hydroxylamine, and N,N-dialkylhydroxylamine derived from hydrogenated tallow amine (that is, N,N-di(tallow alkyl)hydroxylamine); as well as mixtures containing any of the foregoing.

In one embodiment, the first stabilizer additive is a benzofuranone stabilizer known in the art, such as 3-(4-(2-acetoxyethoxy)phenyl)-5,7-di-tert-butyl-benzofu ran-2-one, 5,7-di-tert-butyl-3-(4-(2-stearoyloxyethoxy) phenyl)benzofuran-2-one, 3,3′-bis(5,7-di-tert-butyl-3-(4-(2-hydroxyethoxy) phenyl)benzofu ran-2-one), 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-dimethyl-4-pivaloyloxyphenyl)-5,7-di-tert-butyl-benzofu ran-2-one, 3-(3,4-dimethylphenyl)-5,7-di-tert-butyl-benzofuran-2-one, 3-(2,3-dimethylphenyl)-5,7-di-tert-butyl-benzofuran-2-one.

In yet another embodiment, the first stabilizer additive is a quinone methide stabilizer, as disclosed for example in U.S. Pat. Nos. 5,583,247, 5,616,774, 5,670,692 and 5,750,765, all incorporated herein by reference.

In one embodiment, the first stabilizer additive is a monoacrylate ester of compounds selected from the group consisting of 2,2′-methylenebis(6-tert-butyl-4-methylphenol), 2,2′-methylenebis(6-tert-butyl-4-ethylphenol), 2,2′-methylenebis[4-methyl-6-(a-methylcyclohexyl)phenol], 2,2′-methylenebis(4-methyl-6-cyclohexylphenol), 2,2′-methylenebis(6-nonyl-4-methylphenol), 2,2′-methylenebis (4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-a-methylbenzyl)-4-nonylphenol], 2,2′-methylenebis[6-(a,oc-dimethylbenzyl)-4-nonylphenol], 2,6-bis(3-tert-butyl-5-methyl-2-hydroxybenzyl)-4-methylphenol and 1,1-bis-(3,5-dimethyl-2-hydroxyphenyl)butane. In one example, the first additive is a monoacrylate ester of 2,2′-methylenebis(6-tert-butyl-4-methylphenol), available from Ciba Specialty Chemicals as Irganox 305.

Second Stabilizer Additive: In one embodiment of the invention, the stabilizer additive is an organophosphite. In one embodiment, the organophosphite may be at least one compound of the formula 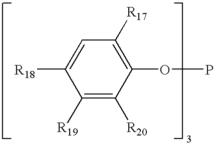
in which R17 and R18 independently of one another are hydrogen, C,-C8 alkyl, cyclohexyl or phenyl, and R19 and R20 independently of one another are hydrogen or C1-C4 alkyl.

In yet another embodiment, the organic phosphites and phosphonites are selected from the group of: triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl methylphenyl) pentaerythritol diphosphite, bisisodecyloxy-pentaerythritol diphosphite, bis(2,4-di-tert-butyl methylphenyl) pentaerythritol diphosphite, bis(2,4,6-tri-tert-butylphenyl) pentaerythritol diphosphite, tristearyl sorbitol triphosphite, tetrakis (2,4-di-tert-butylphenyl) 4,4′-biphenylenediphosphonite, 6-isooctyloxy2A8,10-tetra-tert-butyl-dibenzo [d,f][1 3,2]dioxaphosphepin, 6-fluoro-2,4,8,10 tetra-tert-butyl methyl-dibenzol [d,g][1,3,2]dioxaphosphocin, bis(2,4-di-tertbutyl methylphenyl) methyl phosphite, and bis(2,4-di-tert-butyl methylphenyl) ethyl phosphite.

In one embodiment, organic phosphites and phosphonites may for example be commercially available products such as: tris(2,4-di-tert-butylphenyl) phosphite, bis(2,4-di-tert-butyl methylphenyl) ethyl phosphite, tetrakis(2,4-di-tert-butylphenyl) 4,4′-biphenylenediphosphonite, 2′,2′2″-nitrilo[triethyltris(3,3′5,5′-tetra-tert-butyl-1,1′-biphenyl-2,2′-diyl)phosphite], all from Ciba Geigy Chemicals, Doverphos® S9228 from Dover Chemicals, Mark® HP10 from Adeka Argus, 2,2′-ethylidenebis (2,4-di-tert-butylphenyl) fluorophosphite from Ethyl Corp., bis(2,4-di-tert-butylphenyl) pentaerythritol diphosphite and Ultranox® 641 from GE Specialty Chemicals,

Optional Additives. The composition of the invention may further comprise not more than 30 parts by weight (per 100 parts by weight of the polymer resin component) of a flame retardant aid selected from carbon powder, a phosphorus containing compound, a transition metal compound an acrylic fiber and a novoloid fiber.

The flame retardant aid suitable for use in the present invention includes carbon powders such as carbon black, activated carbon and graphite; phosphorus-containing compounds such as red phosphorus, ammonium polyphosphate, triphenyl phosphate, trixylyl phosphate and xylenyl diphenyl phosphate; transition metal compounds such as nickel oxide, cobalt oxide, manganese oxide, iron oxide, copper oxide, zinc oxide, zirconium oxide, vanadium oxide, Titan Yellow pigment, zirconium silicate, molybdenum oxide, zinc molybdate, zinc stannate and tin oxide; and organic fibers which are carbonized at a high temperature such as an acrylic fiber and a novoloid fiber. The flame retardant aid may be surface-treated as required.

The flame-retardant polymer resin composition of the present invention may further contain a variety of additives, reinforcement materials and fillers which are generally used in polymer compositions. Examples of these additives, reinforcement materials and fillers include an alkaline oxide, an antioxidant, an ultraviolet absorbent, a photostabilizer, a metal deactivating agent, a crosslinking agent, a colorant, a curing agent, a nucleating agent, a foaming agent, a deodorant, lithopone, clay, a wood powder, a glass fiber, ferrite, talc, mica, wollastonite, calcium carbonate, fibrous magnesium hydroxide, fibrous basic magnesium sulfate, a metal fiber and a metal powder. Alkali metal salts and alkaline earth metal salts of higher fatty acids, such as for example, calcium stearate, zinc stearate, magnesium stearate, hydrotalcites and synthetic hydrotalcites may also be used. Hydroxy carbonates, magnesium zinc hydroxycarbonates, magnesium aluminium hydroxycarbonates, aluminium zinc hydroxycarbonates may also be used.

In one embodiment, other optional stabilizers/additives are added in an amount of about 10-5000 ppm. In a second embodiment, the stabilizers/additives are selected from the group consisting of 3-arylbenzofuranones, stabilizers, ultraviolet light absorbers, and alkaline metal salts of fatty acids.

Processing the Flame-Retardant Polymer Compositions. Various known processes can be used to prepare the compositions of the present invention. In one embodiment, the composition can made by combining and mixing, preferably melt mixing, the individual components of the composition. In another embodiment, the metal hydroxide flamed retardants and/or the stabilizers are used in a premixed form (e.g., with a polyolefin in a masterbatch form) rather than as individual components. In yet another embodiment, the components are combined and mechanically mixed in a Banbury mixer, a Brabender mixer, a roll mill, a kneader, or other similar mixing device, and then formed into the desired form or configuration such as by extrusion followed by comminution into granules or pellets, or by other known methods.

The flame retardant polymer pellets can be further processed by conventional techniques, such as sheet extrusion, vacuum forming, injection molding, blow molding, compression molding or in particular, rotational molding, to fabricate plastic components or parts for use in applications intended for exterior weatherable applications and as such will be exposed to prolonged periods of light and weathering, for example, vinyl corrugated roofing, door stripping, and other exterior applications.

### EXAMPLES

Examples are provided herein to illustrate the invention but are not intended to limit the scope of the invention. The additives were compounded into polypropylene resin, e.g. commercially available from Basell as Profax R 6301.

In the examples, the blended stabilized resin formulations are extruded at 100 rpm from 1 inch (2.5 cm) diameter extruder at 500° F. (260° C.) using a Killion extruder. The blended stabilized resin formulation was compounded under inert at 230° C. and multipass extrusion at 260° C. After each of the first, third and fifth extrusions, resin pellets are compression molded into 125 mil (3.2 mm) thick plaques at 370° F. (188° C.).

The specimen samples are measured for Yellowness index (YI) with a low YI value indicates less yellowing (better color stabililty). Additionally, the melt flow rate (MFR in grams/10 minutes) per ASTM-D)-1238 is also measured on the pellets after the first, third and fifth extrusions. The closer (the lower) the melt flow rate after the fifth extrusion is to the melt flow rate after the first extrusion indicates the superior process stabilization of polypropylene.

The following materials are used in the examples in the Table:

Amineoxide: GENOX EP (a dialkylmethyl amine oxide) available from GE Specialty Chemicals (GESC) in Morgantown, W. Va.

Hydoxylamine: Irgastab® FS042 [for example N,N-di(alkyl)hydroxylamine produced by direct oxidation of N,N-di(hydrogenated tallow)amine] available from Ciba Specialty Chemicals of Tarrytown, N.Y.

Phenol: Tetrakis[methylene(3,5-di-tert-butyl-4-hydroxyhydrocinnamate)]methane; A commercially available hindered phenol available from GESC (U-210).

Phosphite-1: a phosphite antioxidant with chemical name tris (2,4 di-tert-butylphenyl) phosphite, form GESC (Ultranox® 668).

Phosphite-2: 2,4,6-tri-butylphenyl-2-butyl-2-ethyl-1,3-propanediol phosphite, a commercially available phosphite from GESC (Ultranox® 641).

Profax® 6301 polypropylene homopolymer from Basell.

Magnesium hydroxide Mg(OH)₂. In all examples, the hydrated metal used as a flame retardant is in the form of 70% concentrate magnesium hydroxide provided by Washington Penn Plastics.

The results of the experiments are included in Table below.

As observed, formulations containing amine oxide (# 5) or hydroxyl amine (# 7) in the presence of Mg(OH)2 give comparable melt flow to the control sample (# 3; as stabilized with phenol and phoshite). Additionally, formulations # 5 and 7 give better color than the control sample (# 3). Incorporation of the synergistic stabilizer, e.g., amine oxide or hydroxylamine in conjunction with organophoshite, in formulations # 8,9, and 10 exhibit better melt flow and superior color compared to the control sample # 3.

While only certain features of the invention have been illustrated and described herein, many modifications and changes will occur to those skilled in the art. It is, therefore, to be understood that the appended claims are intended to cover all such modifications and changes as fall within the true spirit of the invention.

| | Formulation | | | | | | | | | |
|---|---|---|---|---|---|---|---|---|---|---|
| | 1 | 2 | 3 | 4 | 5 | 6 | 7 | 8 | 9 | 10 |
| Phenol | — | 0.05 | 0.05 | — | — | — | — | — | — | — |
| Phosphite-1 | — | 0.1 | 0.1 | — | — | — | — | — | — | 0.1 |
| Phosphite-2 | — | — | — | — | — | — | — | 0.03 | 0.03 | |
| Amine Oxide | — | — | — | 0.05 | 0.05 | — | — | 0.03 | — | 0.03 |
| Hydroxyl Amine | — | — | — | — | — | 0.05 | 0.05 | — | 0.03 | — |
| DHT-4A | 0.02 | 0.02 | 0.02 | 0.02 | 0.02 | 0.02 | 0.02 | 0.02 | 0.02 | 0.02 |
| Mg(OH)₂ | 10 | | 10 | | 10 | | 10 | 10 | 10 | 10 |
| Melt Flow | | | | | | | | | | |
| Compound | 14.2 | 13.0 | 13.1 | 13.0 | 12.6 | 11.5 | 12.1 | 11.96 | 11.8 | 11.9 |
| 1^{st} Pass | 20.8 | 14.1 | 14.3 | 15.7 | 14.0 | 15.5 | 14.5 | 13.1 | 12.9 | 13.4 |
| 3^{rd} Pass | 31.9 | 17.9 | 16.3 | 19.5 | 19.3 | 19.0 | 17.4 | 15.75 | 14.9 | 15.7 |
| 5^{th} Pass | 45.1 | 20.1 | 22.2 | 23.0 | 24.7 | 24.3 | 23.0 | 20.0 | 18.5 | 19.4 |
| Yellowness Index-YI | | | | | | | | | | |
| Compound | 7.07 | 4.62 | 8.81 | 2.85 | 7.92 | 2.47 | 6.93 | 6.41 | 7.49 | 6.85 |
| 1^{st} Pass | 9.25 | 6.13 | 11.89 | 3.57 | 10.29 | 3.1 | 9.0 | 9.39 | 8.39 | 9.22 |
| 3^{rd} Pass | 10.8 | 7.3 | 14.62 | 4.27 | 12.48 | 3.36 | 10.29 | 11.18 | 9.3 | 11.06 |
| 5^{th} Pass | 12.1 | 8.04 | 16.67 | 4.49 | 13.22 | 3.55 | 11.15 | 12.06 | 10.35 | 12.28 |

1. A stabilized flame retardant composition comprising:
at least one of a polymer resin;
about 5 to 300 parts by weight of a hydrated metal compound per 100 parts by weight of said polymer resin;
an effective stabilizing amount of a synergistic mixture of:
a) a first stabilizer comprising at least one compound selected from the group consisting of: amine oxide stabilizers, hydroxylamine stabilizers, nitrone stabilizers, nitroxyl stabilizers, benzofuranone stabilizers; quinone methide stabilizers, and monoacrylate esters of 2,2′-alkylidenebisphenol stabilizers; and
b) a second stabilizer comprising at least one compound selected from the group consisting of phosphite and phosphonite stabilizers.

2. The stabilized flame retardant composition of claim 1, wherein said hydrated metal compound is a metal hydrates or metal oxide.

3. The stabilized flame retardant composition of claim 1, wherein said metal hydroxide is selected from magnesium hydroxide and aluminum hydroxide.

4. The stabilized flame retardant composition of claim 3, wherein said polymer resin is one of a polypropylene, polyethylene, Polypropylene blends, e.g. thermoplastic olefin (TPO), thermoplastic elastomer (TPE).

5. The stabilized flame retardant composition of claim 1, wherein said first stabilizer additive is an amine oxide.

6. The stabilized flame retardant composition of claim 1, wherein said first stabilizer additive is a hydroxyl amine.

7. The stabilized flame retardant composition of claim 3, containing at least 5 parts by weight of a magnesium hydroxide per 100 parts by weight of a polypropylene.

8. A process for the stabilization of a composition comprising at least a polymer resin and about 1 to 100 parts by weight of a hydrated metal compound per 100 parts by weight of said polymer resin, said process comprising adding to a polymer resin composition an effective stabilizing amount of a stabilizer additive selected from one of an amine oxide or a hydroxyl amine.

9. The process of claim 8, wherein said hydrated metal compound is a metal hydroxide.

10. The process of claim 8, wherein said a metal hydroxide is selected from magnesium hydroxide and aluminum hydroxide.

11. The process of claim 8, wherein said polymer resin is a polyolefin.

12. A process for forming articles having improved melt stability and color stability, said process comprising the steps of:
a) melt blending a composition comprising:
at least one of a polymeric resin;
about 1 to 100 parts by weight of a hydrated metal compound per 100 parts by weight of said polymeric resin; and
an effective stabilizing amount of a synergistic mixture of a first stabilizer additive selected from one of an amine oxide or a hydroxyl amine and a second stabilizer additive selected from one of a phosphite or phosphonite stabilizer;
b) forming shaped articles thereof from said blend.

13. Articles comprising the composition of claim 1.

14. The process of claim 12, wherein said polymeric resin is one of a polypropylene, polyethylene, or polypropylene blends.

15. The process of claim 12, wherein said hydrated metal compound is a metal hydrates or metal oxide.

16. The process of claim 12, wherein said stabilizer additive is a hydroxyl amine.

17. The stabilized flame retardant composition of claim 3, containing at least 5 parts by weight of a magnesium hydroxide per 100 parts by weight of a polypropylene.

18. The stabilized flame retardant composition of claim 1, further comprising at least one of an alkaline metal oxide, an alkali metal salt, and an alkaline earth metal.

19. The stabilized flame retardant composition of claim 18, further comprising a calcium carbonate.
